(19) United States
(12) Patent Application Publication
(10) Pub. No.: US 2021/0121824 A1
(43) Pub. Date: Apr. 29, 2021

(54) IMPROVED FILTER CORE STRUCTURE

(71) Applicants: Xiaoping CHEN, Guangdong (CN); FOSHAN VIOMI ELECTRICAL TECHNOLOGY CO., LTD., Guangdong (CN)

(72) Inventor: Xiaoping CHEN, Guangdong (CN)

(21) Appl. No.: 16/616,990

(22) PCT Filed: May 24, 2018
(86) PCT No.: PCT/CN2018/088207

§ 371 Date: Nov. 26, 2019

(30) Foreign Application Priority Data
May 27, 2017 (CN) 201720607500.0

(51) Int. Cl. B01D 61/14; B01D 39/20; B01D 29/35; B01D 29/58; C02F 1/44

(52) U.S. Cl. CPC B01D 61/145; B01D 39/2055; C02F 1/444; B01D 29/58; B01D 29/353

(57) ABSTRACT

Disclosed is an improved filter core structure, comprising a filter core housing (1), the filter core housing (1) respectively comprising an upper area (11) and a lower area (12) according to high to low positions, the upper area (11) and the lower area (12) being in mutual communication, the upper area (11) being provided with a front filter core (2), the lower area (12) being provided with a kernel filter core (3), and the front filter core (2) comprising at least two filtering materials, and an inner layer core (21) and an outer layer core (22) provided according to position from inside to outside.

### BACKGROUND OF THE INVENTION

The present invention relates to a water filter element, particularly an improved filter element structure.

A filter element in the prior art has various structures and styles. However, a water flow passage of a single filter element still has the following deficiencies: (1) due to a single structure of the conventional filter element, water generally flows into one end of the water flow passage and flows out from the other end thereof. That is, since water flow is almost straight, a rate of the water flow is faster, and a filtering effect is poor. Further, since the water flows into one end and flows out the opposite end, a water intake and a water outtake of the filter element are connected, and the directions are different, which not only causes the overall volume to be too large, but also limits the application of the filter element to a certain extent.

### BRIEF SUMMARY OF THE INVENTION

The object of the present invention is to overcome the deficiencies of the prior art described above, and to provide an improved filter core structure, which is simple, reasonable, compact and small, advantageous in improving filtration effect, and widely applicable.

The object of the present invention is achieved in this way:

An improved filter element structure includes a filter element housing, wherein the filter element housing includes an upper region and a lower region according to high and lower positions respectively; the upper region and the lower region are in communication with each other; the upper region is provided with a prepositive filter element; the lower region is provided with a core filter element, and the prepositive filter element includes at least two filter materials, and an inner layer core and an outer layer core that are arranged according to inner and outer positions. Therefore, the upper region and the lower region are arranged on the filter housing, and the prepositive filter element and the core filter element are arranged on the two regions, respectively. Since the prepositive filter element comprises an inner layer core and an outer layer core, water enters the inner layer core from the outer layer core and then flows down to a core filter element below. A water flow direction is changed, and a flow rate is decreased in the same unit volume, which is beneficial to improve a filtering effect of the water flow. Moreover, the inner and outer layer cores cooperate with upper and lower cores to make the structure of the whole filter element more compact and smaller. More importantly, due to the change of the water flow direction, the positions of a total inlet and a total outlet of a filter element can not be limited, and can be installed on the same side or different sides, so that the filter element can be installed more flexibly has a wide range of applications and a simple and reasonable structure.

The object of the present invention can also be achieved by the following technical measures:

Further, the outer layer core is a PP folded filter element. The inner layer core is a hollow carbon rod composite filter element. The PP folded filter element is wrapped on the outer wall of the carbon rod composite filter element to form a structure with inner and outer layers, which is easy to implement and has a simple structure and is easy to be disassembled.

Further, the inner layer core and the outer layer core are arranged at the upper portion in a vertical manner, so that water flowing into the inner layer core flows downward into the core filter element.

Further, the core filter element may be an ultrafiltration UF, and the ultrafiltration UF is arranged at the lower portion in the vertical manner for better filtration of water and for cooperation with an upper vertical filter element to form upper and lower positions. Therefore, the structure is more compact and reasonable.

Further, a central water outlet pipe is further comprised and comprises an upper end inlet and a lower end outlet. The upper end inlet is in communication with the hollow carbon rod composite filter element. The lower end outlet is in communication with an inlet of the ultrafiltration UF. The central water outlet pipe serves as a total outlet of the prepositive filter element, and introduces the water filtered through the prepositive filter into the ultrafiltration UF below.

Further, the central water outlet pipe comprises a pipe upper section, an extension platform and an interface lower section. The extension platform is arranged on an outer wall of a joint between the pipe upper section and the interface lower section. The pipe upper section and the interface lower section are in communication with each other. The pipe upper section is inserted into an inner cavity of the hollow carbon rod composite filter element. The interface lower section is inserted into an upper inlet of the ultrafiltration UF, so that the water in the inner cavity of the carbon rod composite filter element of the prepositive filter element flows quickly down through the pipe upper section of the central water outlet pipe to ensure a water outlet rate.

Further, the inner layer core and the outer layer core constitute a hollow cylindrical prepositive filter element. The cylindrical prepositive filter is sleeved outside the pipe upper section of the central water outlet pipe via an inner cavity of the carbon rod composite filter element of the inner layer core, In addition, the bottom of the cylindrical prepositive filter element is placed on the extension platform of the central water outlet pipe. The extension platform can serve as a platform of the prepositive filter element, so that a product structure is more reasonable.

Further, the top of the cylindrical prepositive filter element is provided with a core cover of the prepositive filter element, The middle of the top cover of the prepositive filter element is provided with a downward extending portion. The downward extending portion is inserted into the upper portion of the inner cavity of the carbon rod composite filter element of the inner layer core of the prepositive filter element to cover the upper portion of the inner cavity of the carbon rod composite filter element of the inner layer core.

Further, the central water outlet pipe is arranged in the filter element housing. A portion at the inner cavity of the filter element housing above the extension platform of the central water outlet pipe is the upper region, and a portion at the inner cavity of the filter element housing below the extension platform is the lower region. The lower region is lower than the upper region. Thus, due to the bigger height of the upper region, the height of the prepositive filter element is relatively big. Water enters the upper region from the lower region of the bottom. Due to the bigger height of the prepositive filter element, the water enters via from an outer wall (periphery) of the prepositive filter element. Therefore, water inlet surface is larger, which not only increases the water flow rate, but also ensures the uniform filter area of the prepositive filter element and improves a filtering effect.

Further, the bottom of the filter element housing is provided with a water inlet and a water outlet. The water outlet is in communication with the core filter element. The water inlet is communication with the upper region via the periphery of the core filter element; that is, the water inlet and the water outlet are both enters and exits from the bottom of the filter housing, so the external connection thereof is more compact.

The beneficial effects of the present invention are as follows:

(1) Therefore, the upper region and the lower region are arranged on the filter housing, and the prepositive filter element and the core filter element are arranged on the two regions, respectively. Since the prepositive filter element comprises an inner layer core and an outer layer core, water enters the inner layer core from the outer layer core and then flows down to a core filter element below, A water flow direction is changed, and a flow rate is decreased in the same unit volume, which is beneficial to improve a filtering effect of the water flow. Moreover, the inner and outer layer cores cooperate with upper and lower cores to make the structure of the whole filter element more compact and smaller. More importantly, due to the change of the water flow direction, the positions of a total inlet and a total outlet of a filter element can not be limited, and can be installed on the same side or different sides, so that the filter element can be installed more flexibly has a wide range of applications and a simple and reasonable structure.

(2) Further, the outer layer core is the PP folded filter element. The inner layer core is the hollow carbon rod composite filter element. The PP folded filter element is wrapped around the outer wall of the carbon rod composite filter element to constitute a structure with inner and outer layers, which is easy to implement, has a simple structure and is easy to be disassembled

(3) By adding the central water outlet pipe, the central water outlet pipe serves as the total outlet of the prepositive filter element and introduces the water filtered through the prepositive filter element into the ultrafiltration UF below. Water in the inner cavity of the carbon rod filter composite filter element of the prepositive filter element flows down quickly through the pipe upper section of the central water outlet pipe to ensure the water discharge rate. the extension platform can serve as a platform of the prepositive filter element to make the product structure more reasonable.

### BRIEF DESCRIPTION OF THE DRAWINGS

FIG. 1 is a view of an improved filter element structure of the present invention,

### DETAILED DESCRIPTION OF THE INVENTION

The present invention will be further described below in conjunction with the accompanying drawings and embodiments:

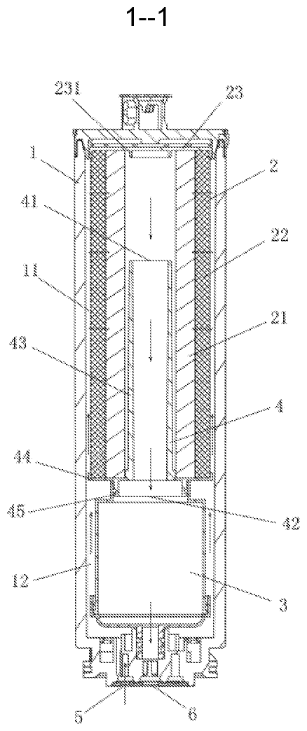

Referring to FIG. 1, an improved filter element structure comprises a filter element housing 1, wherein the filter element housing I comprises an upper region 11 and a lower region 12 according to high and lower positions, respectively. The upper region 11 and the lower region 12 are in communication with each other. The upper region 11 is provided with a prepositive filter element 2, and the lower region 12 is provided with a core filter element 3. The prepositive filter element 2 comprises at least two filter materials, and an inner layer core 21 and an outer layer core 22 that are arranged according to inner and outer positions. The outer layer core 22 is a PP folded filter element. The inner layer core 21 is a hollow carbon rod composite filter element, The PP folded filter s wrapped on an outer wall of the carbon rod composite filter element.

The inner layer core 21 and the outer layer core 22 are arranged at the upper region 11 in a vertical manner. The core filter element 3 is an ultrafiltration UF, and the ultrafiltration UF is arranged at the lower region 12 in the vertical manner.

As a more specific solution, a central water outlet pipe 4 may be further comprised and comprises an upper end inlet 41 and a lower end outlet 42. The upper end inlet 41 is in communication with the hollow carbon rod composite filter element, and the lower end outlet 42 is in communication with an inlet of the ultrafiltration UF.

The central water outlet pipe 4 comprises a pipe upper section 43, an extension platform 44 and an interface lower section 45. The extension platform 44 is arranged on an outer wall of a joint between the pipe upper section 43 and the interface lower section 45. The pipe upper section 43 and the interface lower section 45 are in communication with each other. The pipe upper section 43 is inserted into an inner cavity of the hollow carbon rod composite filter element, and the interface lower section 45 is inserted into an upper inlet of the ultrafiltration UF.

The inner layer core 21 and the outer layer core 22 constitute a hollow cylindrical prepositive filter element 2, and the cylindrical prepositive filter element 2 is sleeved outside the pipe upper section 43 of the central water outlet pipe 4 via at a lower portion of the inner cavity of the carbon rod composite filter element of the inner layer core 21, and the bottom of the cylindrical prepositive filter element 2 is placed on the extension platform 44 of the center outlet pipe 4.

The top of the cylindrical prepositive filter element 2 is provided with a top cover 23 of the prepositive filter element 23. The middle of the top cover 23 of the prepositive filter element is provided with a downward extending portion 231, and the downward extending portion 231 is inserted into the upper portion of the inner cavity of carbon rod composite filter element of the inner layer core 21 of the prepositive filter element 2. The central water outlet pipe 4 is arranged in the filter element housing 1. A portion at the inner cavity of the filter element housing 1 above the extension platform 44 of the central water outlet pipe 4 is the upper region 11, and a portion at the inner cavity of the filter element housing 1 above the extension platform 44 of the central water outlet pipe is the lower region 11. The lower region 12 is higher than the upper region 11.

The bottom of the filter element housing 1 is provided with a water inlet 5 and a water outlet 6. The water outlet 6 is in communication with the core filter element 3, and the water inlet 5 is in communication with the upper region 11 via a periphery of the core filter element 3.

Working principle: water enters from the water inlet 5 at the bottom of the filter housing 1, is rushed upwards along the lower region 12 at the periphery of the core filter element 3, enters the upper region 11 the periphery of the prepositive filter element 2, enters the inner layer core 21 via a side wall of the outer layer core 22 of the prepositive filter element 2, is performed with initial filtration, flows down into the core filter element 3 via the central water outlet pipe 4 for secondary filtration, and is finally discharged from the water outlet 6 via the water outlet 6.

1. An improved filter element structure, comprising a filter element housing a), wherein the filter element housing a) comprises an upper region (11) and a lower region (12) according to high and lower positions, respectively, the upper region (11) and the lower region (12) are in communication with each other, the upper region (11) is provided with a prepositive filter element (2), the lower region (12) is provided with a core filter element (3), the prepositive filter element (2) comprises at least two filter materials, and an inner layer core (21) and an outer layer core (22) that are arranged according to inner and outer positions.

2. The improved filter element structure according to claim 1, wherein the outer layer core (22) is a PP folded filter element, the inner layer core (21) is a hollow carbon rod composite filter element, and the PP folded filter element is wrapped in an outer wall of the carbon rod composite filter element.

3. The improved filter element structure according to claim 1, the inner layer core (21) and the outer layer core (22) are arranged at the upper region (11) in a vertical manner.

4. The improved filter element structure according to claim 2, wherein the core filter element (3) is an ultrafiltration UF, and the ultrafiltration UF is arranged at a lower portion (12) in the vertical manner.

5. The improved filter element structure according to claim 4, further comprising a central water outlet pipe (4), the central water outlet pipe (4) comprising an upper end inlet (41) and a lower end outlet (42), and an upper end inlet (41) is in communication with the hollow carbon rod composite filter element, and the lower end outlet (42) is in communication with an inlet of the ultrafiltration UF.

6. The improved filter element structure according to claim 5, wherein the central water outlet pipe (4) comprises a pipe upper section (43), an extension platform (44) and an interface lower section (45), the extension platform (44) is arranged on an outer wall of a joint between the pipe upper section (43) and the interface lower section (45), the pipe upper section (43) and the interface lower section (45) are in communication with each other, the pipe upper section (43) is inserted into an inner cavity of the hollow carbon rod composite filter, and the interface lower section (45) is inserted into an upper inlet of the ultrafiltration UF.

7. The improved filter element structure according to claim 6, wherein the inner layer core (21) and the outer layer core (22) constitute a hollow cylindrical prepositive filter element (2), the cylindrical prepositive filter element (2) is sleeved outside the upper portion (43) of the central water outlet pipe (4) via a lower portion of an inner cavity of the carbon rod composite filter element of the inner layer core (21), and the bottom of the cylindricai prepositive filter element (2) is placed on the extension platform (44) of the central water outlet pipe (4).

8. The improved filter element structure according to claim 7, wherein the top of the cylindrical prepositive filter (2) is provided with a top cover (23) of a prepositive filter, the middle of the top cover (23) of the prepositive filter element is provided with a downward extending portion (231), the downward extending portion (231) is inserted into and the upper portion of the inner cavity of the carbon rod composite filter element of the inner layer core (21) of the prepositive filter element (2).

9. The improved filter element structure according to claim 6, wherein the central water outlet pipe (4) is arranged in the filter element housing (1), a portion at an inner cavity of the filter element housing above the extension platform (44) of the central water outlet pipe (4) is the upper region (11), a portion at the inner cavity of the filter element housing (1) below the extension platform (44) is the lower region (12), and the lower region (12) is lower than the upper region (11).

10. The improved fitter element structure according to claim 1, wherein the bottom of the filter element housing 1 is provided with a water inlet (5) and a water outlet (6), and the water outlet (6) is in communication with the core filter element (3), and the water inlet (5) is in communication with the upper region (11) via a periphery of the core filter element (3).
